(19) United States
(12) Patent Application Publication
(10) Pub. No.: US 2011/0141358 A1
(43) Pub. Date: Jun. 16, 2011

(54) Illuminated bezel information display

(76) Inventors: Robert L. Hardacker, Escondido, CA (US); Steven Richman, San Diego, CA (US); Rafael Calderon, San Diego, CA (US); Fred J. Zustak, Poway, CA (US)

(21) Appl. No.: 12/653,348

(22) Filed: Dec. 11, 2009

(51) Int. Cl. H04N 5/445; H04N 5/50

(52) U.S. Cl. 348/563; 348/731; 348/E05.099; 348/E05.097

(57) ABSTRACT

A configured display mode is determined for a two-dimensional light-emitting diode (LED) array located within a bezel of the display device outside of the display area of the display. Information associated with the configured display mode is retrieved for the two-dimensional LED array. The information associated with the configured display mode is displayed via the two-dimensional LED array. This abstract is not to be considered limiting, since other embodiments may deviate from the features described in this abstract.

### CROSS REFERENCE TO RELATED DOCUMENTS

This application is related to concurrently filed U.S. utility patent application Ser. No. ______, titled “USER PERSONALIZATION WITH BEZEL-DISPLAYED IDENTIFIER,” which is incorporated herein by reference in its entirety.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

Television and other display devices include display units that allow these devices to render visual content. These display units are typically surrounded by a framed enclosure that surrounds the display unit and that protects electronic circuitry and mechanical components associated with the respective display device from impact and other environmental factors. The framed enclosures are often formed from plastic, metal, or other material that provides mechanical rigidity to the display device and that allows the display device to be moved, installed, or stored as a unit.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a diagram of an example of an implementation of a display device for illuminated bezel information display consistent with certain embodiments of the present invention.

FIG. 2 is a block diagram of an example of an implementation of the display device for illuminated bezel information display consistent with certain embodiments of the present invention.

FIG. 3 is a flow chart of an example of an implementation of a process for automated control of illuminated bezel information display consistent with certain embodiments of the present invention.

FIG. 4A is a flow chart of initial processing of an example of an implementation of a process for automated control of illuminated bezel information display consistent with certain embodiments of the present invention.

FIG. 4B is a flow chart of a second portion of an example of an implementation of a process for automated control of illuminated bezel information display consistent with certain embodiments of the present invention.

FIG. 4C is a flow chart of a third portion of an example of an implementation of a process for automated control of illuminated bezel information display consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system having one or more processors.

The term “program”, as used herein, may also be used in a second context (the above definition being for the first context). In the second context, the term is used in the sense of a “television program”. In this context, the term is used to mean any coherent sequence of audio video content such as those which would be interpreted as and reported in an electronic program guide (EPG) as a single television program, without regard for whether the content is a movie, sporting event, segment of a multi-part series, news broadcast, etc. The term may also be interpreted to encompass commercial spots and other program-like content which may not be reported as a program in an electronic program guide.

Reference throughout this document to “one embodiment,” “certain embodiments,” “an embodiment,” “an implementation,” “an example” or similar terms means that a particular feature, structure, or characteristic described in connection with the example is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

The present subject matter provides illuminated bezel information display. For purposes of the present description, the term “bezel” includes a frame area of a display device enclosure that surrounds the display, or any portion of the display, or any part thereof. A bezel is considered to include an area of the enclosure located outside of the rendering display area of the display enclosed within the display device. The bezel is further considered to include any area of the enclosure that is visible from a perspective of a user viewing rendered content on the display area of the display device.

Visual content (e.g. video content), such as a motion picture, television program, or other content, is displayed within a display area of a display device. Such visual content can be from any conventional or unconventional source including, but not limited to broadcast, cable, Telco, Internet, satellite or other sources and may be detected, decoded and/or demultiplexed in any suitable manner to produce a television program viewing-like experience. A configured display mode for an illuminated bezel information display located outside of the display area of the display device is determined. Information associated with the configured display mode for the illuminated bezel information display is retrieved and displayed via the illuminated bezel information display. A viewer may view the information displayed via the illuminated bezel information display without obstruction of the visual content displayed within the display area of the display device.

Configured modes for the illuminated bezel information display include, for example, a television setting display mode, a text display mode, a really simple syndication (RSS) feed display mode, a text message display mode, a stock ticker display mode, a scrolling text mode, an incoming telephone call mode, a static information display mode, a closed caption information display mode, a subtitle display mode, and a warning or error display mode. Many other display modes for the illuminated bezel information display are possible and all are considered within the scope of the present subject matter.

Operatively, the viewer's viewing experience may be improved by providing interaction and informational capabilities via a two-dimensional illuminated bezel information display with both text and graphics capabilities, including color rendering capabilities, outside of the display area of the display device. By partitioning interaction and information processing to a separate two-dimensional illuminated bezel information display, a viewer may continue to view content without interruption from on-screen display of interaction and information, such as on-screen menus.

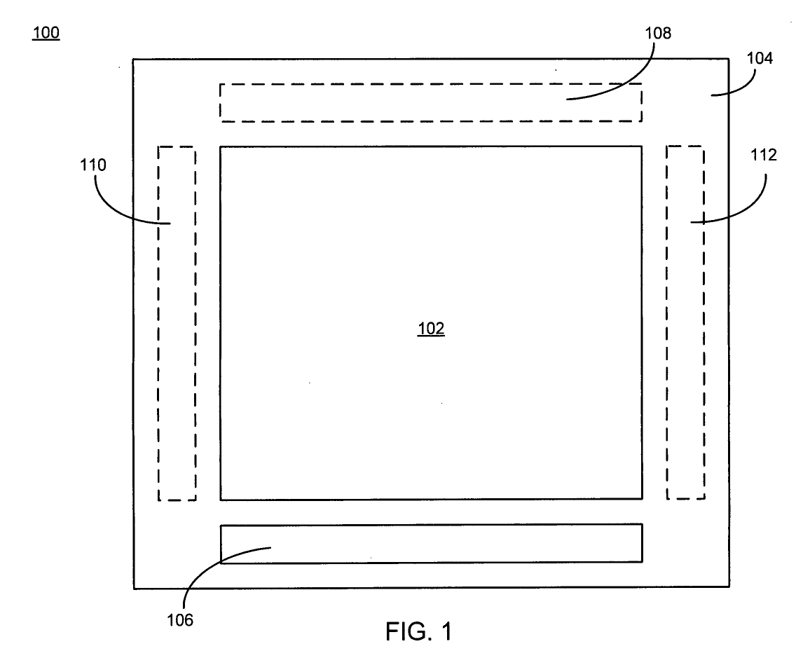

Turning now to FIG. 1, FIG. 1 is a diagram of an example of an implementation of a display device 100 for illuminated bezel information display. The display device 100 includes a display 102 located within an enclosure 104. The display 102 may include any display technology capable of rendering content for viewing, such as a liquid crystal display (LCD), light-emitting diode (LED), cathode ray tube (CRT), projection, touchscreen, or other display element or panel.

The enclosure 104 may be formed or molded from any suitable material for a given implementation, such as plastic, metal, composite, or other material. Further, for purposes of the present description, all areas of the enclosure 104 that are visible from a perspective of a user viewing rendered content on the display 102 are considered a bezel area (e.g., a frame area) of the display device 100. An illuminated bezel information display 106 is shown along a bottom portion of the enclosure 104. The illuminated bezel information display 106, as described in more detail below, is used to display information for a variety of purposes, such as information based upon a configured display mode for the display device 100.

Display of information via the illuminated bezel information display 106 allows the user viewing rendered content on the display 102 to view information associated with the display device 100, information associated with the rendered content, and other information without the displayed information obstructing the user's view of the rendered content. As such, the present subject matter provides for information display and user interaction with a device, such as the display device 100, without compromising the user's view of rendered content.

The illuminated bezel information display 106 may include any form of display suitable for a given implementation. For example, the illuminated bezel information display 106 may include an LED array including one or more different colors of LEDs. Further, the illuminated bezel information display 106 may include a two-dimensional sub-pixel LED array including one or more different colors of LEDs, color-controllable LEDs (e.g., red, green, blue (RGB) LEDs), and/or a low-resolution projector. In the case of a low-resolution projector, the enclosure 104 may be formed, for example, via a two shot (2-shot) injection molding process. A 2-shot injection molding process allows mixture of diffusive material with other materials, such as clear, opaque, or translucent materials, to achieve different visual effects for the enclosure 104. In such an implementation, for example, a projection of information onto a contrasting color or blend created by the 2-shot injection may provide contrast for displayed information. Many other variations of illuminated bezel information display are possible and all are considered within the scope of the present subject matter.

For purposes of the present description, a two-dimensional sub-pixel LED array may include a two-dimensional array of LEDs, where each LED has a resolution smaller than a pixel of information to be displayed. As such, granularity for changes within displayed information (e.g., color variations, etc.) via the illuminated bezel information display 106 may be smaller than a pixel of information to be displayed when implemented as a two-dimensional sub-pixel LED array. Interpolation or other techniques may be used to transition colors or edges of images between adjacent pixels to create a finer resolution than what is encoded within raw information to be displayed. Additionally, more information may be displayed using the improved resolution of a two-dimensional sub-pixel LED array. Accordingly, implementation of the illuminated bezel information display 106 as a two-dimensional sub-pixel LED array provides possibilities for improving resolution for the information during rendering of the information and for allowing more information to be displayed via the illuminated bezel information display 106. Alternatively, the illuminated bezel information display 106 may include a liquid crystal display (LCD), cathode ray tube (CRT), projection, touchscreen, or other display element or panel without departure from the scope of the present subject matter.

An illuminated bezel information display 108, an illuminated bezel information display 110, and an illuminated bezel information display 112 are also illustrated. Each of the illuminated bezel information displays 108, 110, and 112 is depicted within FIG. 1 as a dashed-line representation to illustrate that these respective devices may be alternative locations for the illuminated bezel information display 106 or that they may be additional or separate illuminated bezel information displays of the display device 100, as appropriate for a given implementation. Further, additional illuminated bezel information displays beyond those illustrated within the present example may be included within a device, such as the display device 100. As another alternative, the example illuminated bezel information displays 106, 108, 110, and 112 may also be interconnected at the respective corners of the enclosure 104 to allow information to be displayed around an entire circumference of the display 102. As such, an illuminated bezel information display may be located within any portion of a frame area or bezel, such as the enclosure 104 of the display device 100, outside of the display area of a display, such as the display 102. Further, any or all of the illuminated bezel information displays 106, 108, 110, and 112 may span an entire distance from the display 102 to an outer edge of the enclosure 104 or any portion thereof. As such, up to the entire visible area of the enclosure 104 may be formed using an illuminated bezel information display. Accordingly, many variations are possible for placement of illuminated bezel information displays and all are considered within the scope of the present subject matter.

The display device 100 may be any device capable of rendering and processing information as described above and in more detail below. For example, the display device 100 may include devices such as a television, a personal computer (e.g., desktop, laptop, palm, etc.), a handheld device (e.g., cellular telephone, personal digital assistant (PDA), email device, music recording or playback device, etc.), or any other device capable of rendering and processing information as described above and in more detail below.

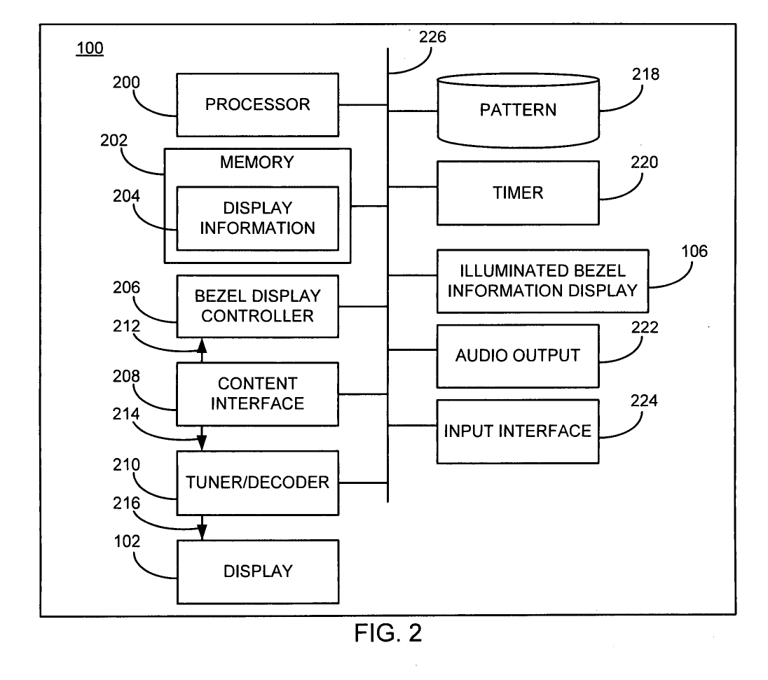

FIG. 2 is a block diagram of an example of an implementation of the display device 100 for illuminated bezel information display. A processor 200 provides computer instruction execution, computation, and other capabilities within the display device 100. The display 102 and the illuminated bezel information display 106 are illustrated.

A memory 202 includes a display information storage area 204 that stores information, such as a configuration mode and other information, associated with control of the illuminated bezel information display 106. It is understood that the memory 202 may include any combination of volatile and non-volatile memory suitable for the intended purpose, distributed or localized as appropriate for a given implementation, and may include other memory segments not illustrated within the present example for ease of illustration purposes. For example, the memory 202 may include a code storage area, a code execution area, and a data area without departure from the scope of the present subject matter.

A bezel display controller 206 controls display of content on the illuminated bezel information display 106. As described in more detail below, the bezel display controller 206 may cause a variety of information to be displayed via the illuminated bezel information display 106.

A content interface module 208 provides communication capabilities for the display device 100. The content interface module 208 may include any form of interconnection suitable for the intended purpose, including a private or public network such as an intranet or the Internet, respectively, direct inter-module interconnection, dial-up, wireless, or any other interconnection mechanism capable of interconnecting the display device 100 to other components for access to content and information for rendering via the display 102 and the illuminated bezel information display 106, respectively, as describe above and in more detail below. It is also understood that the content interface module 208 may include telephone interconnection capabilities via either wireless or wired carrier, and any other interconnection capabilities for accessing content. The content interface module 208 may also include capabilities for text message sending and receiving, RSS feed receipt and processing, and stock ticker information receipt and processing, among other information processing capabilities. The capabilities described above for the content interface module 208 are understood to be within the scope of the present subject matter, but are not described in detail herein for brevity. It is understood that a person of skill in the art will be able to implement such an interface appropriate for a given implementation based upon the description herein.

It should be noted that the bezel display controller 206 and the content interface module 208 are illustrated as component-level modules for ease of illustration and description purposes. It is also understood that the bezel display controller 206 and the content interface module 208 include any hardware, programmed processor(s), and memory used to carry out the respective functions of the bezel display controller 206 and the content interface module 208 as described above and in more detail below. For example, the bezel display controller 206 and the content interface module 208 may include additional controller circuitry in the form of application specific integrated circuits (ASICs), processors, and/or discrete integrated circuits and components for performing electrical control activities associated with the bezel display controller 206 and the content interface module 208. Additionally, the bezel display controller 206 and the content interface module 208 also include interrupt-level, stack-level, and application-level modules as appropriate. Furthermore, the bezel display controller 206 and the content interface module 208 may include any memory components used for storage, execution, and data processing by these modules for performing processing activities associated with the bezel display controller 206 and the content interface module 208. The bezel display controller 206 and the content interface module 208 may also form a portion of other circuitry described below without departure from the scope of the present subject matter.

It should also be noted that the bezel display controller 206 may alternatively be implemented as an application stored within the memory 202. In such an implementation, the bezel display controller 206 may include instructions executed by the processor 200 for performing the functionality described herein. The processor 200 may execute these instructions to provide the processing capabilities described above and in more detail below for the display device 100. The bezel display controller 206 may form a portion of an interrupt service routine (ISR), a portion of an operating system, a portion of a browser application, or a portion of a separate application without departure from the scope of the present subject matter.

A tuner/decoder module 210 receives television (e.g., audio/video) content and decodes that content for display via the display 102. The content may include content formatted either via any of the motion picture expert group (MPEG) standards, or content formatted in any other suitable format for reception by the tuner/decoder module 210. It is understood that the tuner/decoder module 210 may include any hardware, programmed processor(s), and memory used to carry out the functions of the tuner/decoder module 210. For example, the tuner/decoder module 210 may include additional controller circuitry in the form of application specific integrated circuits (ASICs), antennas, processors, and/or discrete integrated circuits and components for performing electrical control activities associated with the tuner/decoder module 210 for tuning to and decoding content received either via wireless or wired connections to the display device 100.

Three directional connections are illustrated in association with the bezel display controller 206, the content interface module 208, the tuner/decoder module 210, and the display 102. A directional connection 212 allows the content interface module 208 to provide received content and information directly to the bezel display controller 206 for rendering via the illuminated bezel information display 106. A directional connection 214 allows the content interface module 208 to provide received content, such as MPEG encoded content received via IP-based communications to the tuner/decoder module 210 for decoding and rendering via the display 102. A directional connection 216 allows the tuner/decoder module 210 to provide decoded content directly to the display 102 for rendering. As such, content received by the content interface module 208 may be routed to either of the bezel display controller 206 or the tuner/decoder module 210 as appropriate for the given information/content, via the directional connection 212 and the directional connection 214, respectively, without additional intervention or control by the processor 200. Additionally, content for display via the display 102 may be routed from the tuner/decoder module 210 to the display 102 via the directional connection 216 without additional intervention or control by the processor 200.

It is noted that, though the present example interconnections are described, other interconnections are possible and are considered within the scope of the present subject matter. For example, additional interconnections may be provided to allow the tuner/decoder module 210 to provide closed caption or other information to the bezel display controller 206 for rendering via the illuminated bezel information display 106. Alternatively, closed captioning or other information may be provided via other connectivity between the modules described below and as illustrated within the present example.

A pattern database 218 provides storage capabilities for information associated with the illuminated bezel information display 106. For example, random pattern information may be stored within the pattern database 218 and displayed as a random continually changing pattern via the illuminated bezel information display 106. The random continually changing pattern may include a random continually changing color pattern, such as, for example, a pattern simulating an effect of different colored heated oils in a lava lamp or other patterns to be used for decoration or illumination purposes. Other information may also be stored within the pattern database 218 as suitable for a given implementation. The pattern database 218 may also include patterns for synchronizing display of random continually changing color patterns with music.

A timer 220 provides timing and time keeping capabilities for the display device 100. The timer 220 may be utilized by the bezel display controller 206, for example, to determine whether an idle time associated with displaying static information via the illuminated bezel information display 106 has expired. In such a situation, the bezel display controller 206 may cause the display of the random continually changing pattern described above and stored within the pattern database 218. Further, the bezel display controller 206 may cause the illuminated bezel information display 106 to display a random continually changing color pattern simulating an effect of different colored heated oils in a lava lamp.

An audio output 222 provides audio output control for the display device 100. The audio output 222 may include appropriate drive circuitry for speakers and other circuitry. However, it is noted that the audio output 222 may include speakers in a given implementation without departure from the scope of the present subject matter. In such an implementation, the display of visual information via the illuminated bezel information display 106 may be synchronized with music.

An input interface 224 provides input capabilities for the user. The input interface 224 may include infra red (IR) circuitry for receiving input signals from a remote control device (not shown). The input interface 224 may also include wireless input interface circuitry. For example, radio frequency (RF) remote control signals or other signals, such as Bluetooth and other circuitry, for receiving user input information as appropriate for a given implementation may also be included. The input interface 224 may also include input circuitry for detecting inputs via a mouse, pen, trackball, keyboard, or other input device. The input interface 224 may include input circuitry sufficient to allow one or more input devices to be used.

The processor 200, the memory 202, the bezel display controller 206, the content interface module 208, the tuner/decoder module 210, the pattern database 218, the timer 220, the audio output 222, the input interface 224, and the illuminated bezel information display 106 are interconnected within the display device 100 via an interconnection 226. The interconnection 226 may include any form of interconnection suitable for a given implementation. For example, the interconnection 226 may include a system bus, a network, or any other interconnection capable of providing the respective components with suitable interconnection for the respective purposes.

While the display device 100 is illustrated with and has certain components described, other modules and components may be associated with the display device 100. Additionally, it should be noted that, while the display device 100 is described as a single device for ease of illustration purposes, the components within the display device 100 may alternatively be distributed and interconnected via a network, such as a home network. Many arrangements are possible for components of the display device 100 and all are considered within the scope of the present subject matter. It should also be understood that, though the pattern database 218 is shown as a separate component, the information stored within the pattern database 218 may be stored within the memory 202 without departure from the scope of the present subject matter. Accordingly, the display device 100 may take many forms.

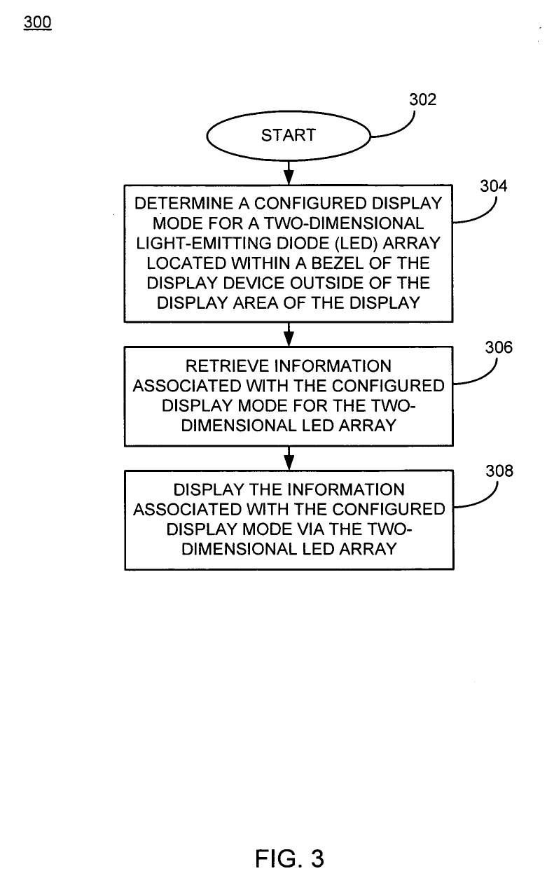

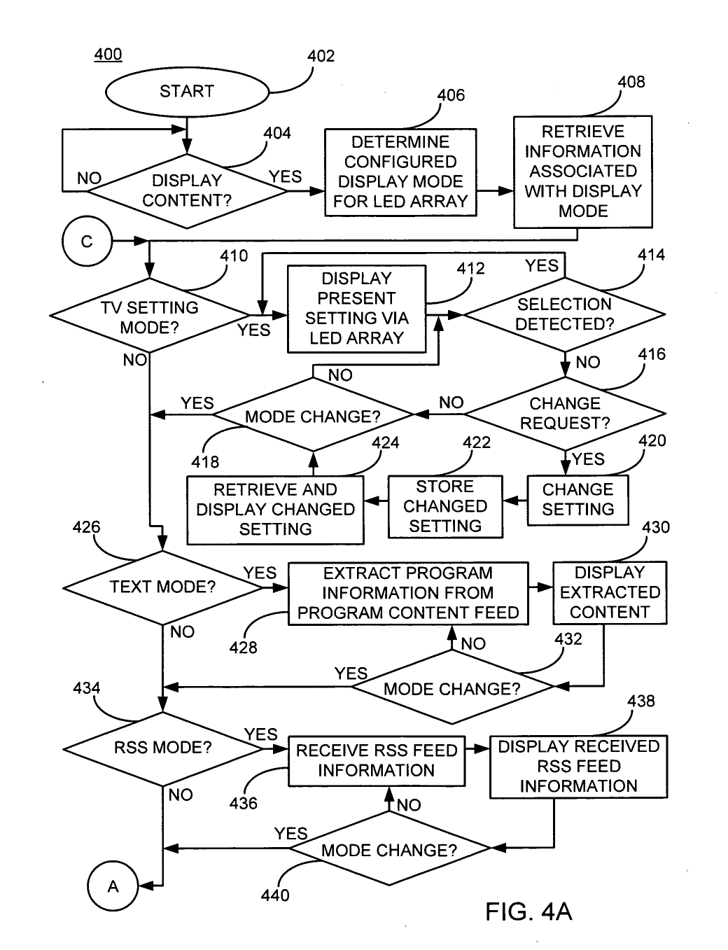

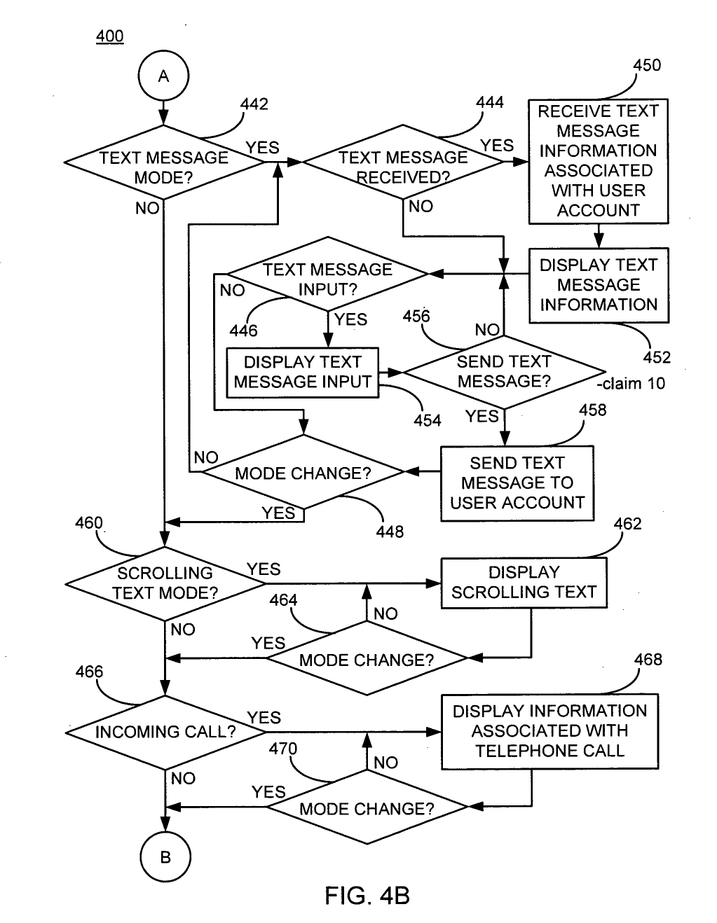

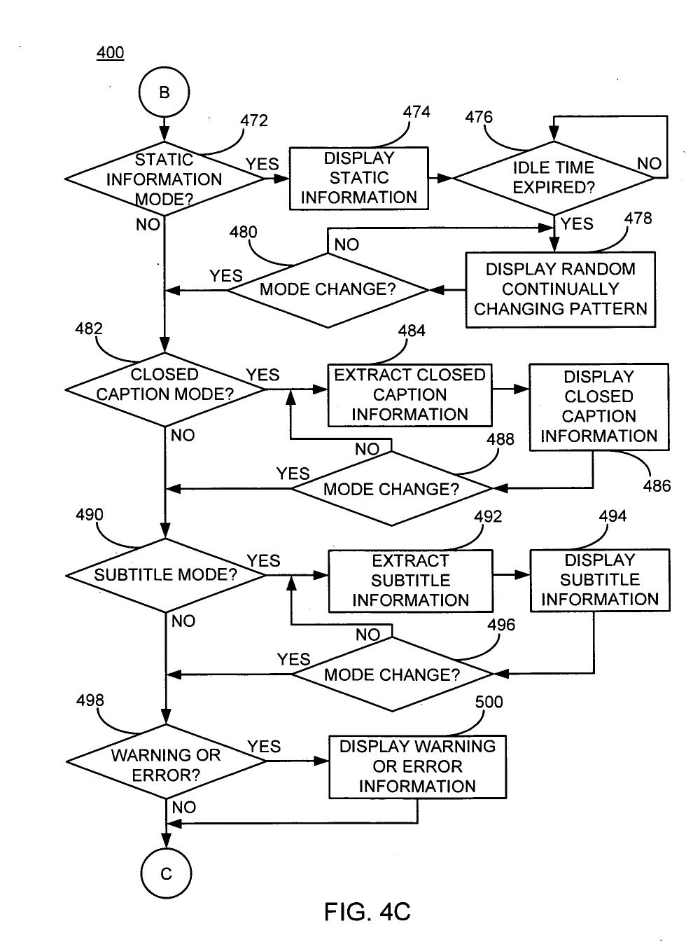

FIG. 3 through FIG. 4C described below provide example processes that may be executed by devices, such as the display device 100, to perform the illuminated bezel information display described herein. Many other variations on the example processes are possible and all are considered within the scope of the present subject matter. The example processes may be performed by modules, such as the bezel display controller 206 and/or executed by the processor 200. Display of video content via the display 102 may be performed by the tuner/decoder module 210 and is illustrated in association with certain aspects of the example processes below for reference purposes. It should be noted that time out procedures and other error control procedures are not illustrated within the example processes described below for ease of illustration purposes. However, it is understood that all such procedures are considered to be within the scope of the present subject matter. Further, certain portions of the processes described below indicate that certain input requests are detected via an input device generally for ease of illustration purposes. However, it is understood that any such detection of an input request may be detected via an input interface component, such as the input interface 224.

FIG. 3 is a flow chart of an example of an implementation of a process 300 for automated control of illuminated bezel information display. The process 300 begins at 302. At block 304, the process 300 determines a configured display mode for an example two-dimensional light-emitting diode (LED) array located within a bezel of the display device outside of the display area of the display. At block 306, the process 300 retrieves information associated with the configured display mode for the two-dimensional LED array. At block 308, the process 300 displays the information associated with the configured display mode via the two-dimensional LED array. While this example depicts an LED array, other video arrays can also be used without limitation.

FIGS. 4A-4C illustrate a flow chart of an example of an implementation of a process 400 for automated control of illuminated bezel information display according to the present subject matter. Within FIGS. 4A-4C, the illuminated bezel information display 106 is referred to as an “LED array” due to space limitations within the drawing space. However, it is understood that the illuminated bezel information display 106 may include any form or technology of display within the scope of the present subject matter.

FIG. 4A illustrates initial processing within the process 400. The process 400 begins at 402. At decision point 404, the process 400 determines whether a request to display content has been detected. A request to display content may be associated with a power-on condition for the display device 100, a channel or content change associated with display device 100, or any other event associated with a content rendering action. When a determination is made that a request to display content has been detected, the process 400 displays the content via the display 102 (not shown within FIG. 4A). The content may be received via the tuner/decoder module 210, either as originally decoded by the tuner/decoder module 210 or as forwarded to the tuner/decoder module 210 via the content interface module 208, as described above. As also discussed above, this additional processing to display content via the display 102 is described for reference purposes. The additional processing described below may be performed by an illuminated bezel information display control module, such as the bezel display controller 206.

At block 406, the process 400 determines a configured display mode for an LED array, such as the illuminated bezel information display 106. The configured display mode for the illuminated bezel information display 106 may include, for purposes of the present example, a television setting display mode, a text display mode, a really simple syndication (RSS) feed display mode, a text message display mode, a scrolling text mode, a static information display mode, a closed caption information display mode, and a subtitle display mode. Many other display modes for the illuminated bezel information display 106 are possible. For example, though not depicted within FIG. 4A-4C for ease of illustration purposes, a stock ticker display mode or other display modes are possible. Accordingly, all such configured display modes are considered within the scope of the present subject matter.

At block 408, the process 400 retrieves information associated with the configured display mode for the LED array, for example, from the display information storage area 204 of the memory 202, or from an incoming information stream or information feed. Additionally, for the television setting display mode, the process 400 may retrieve television setting information from the memory 202. For the text display mode, the process may extract program information from a program content feed associated with the displayed visual content that is rendered via the display 102. For the really simple syndication (RSS) feed display mode, the process 400 may receive RSS feed information associated with a configured RSS feed. For the text message display mode, the process 400 may receive text message information associated with a text message user account associated with a user of the display device 100. For the scrolling text mode and the static information display mode, the process 400 may scroll any received or retrieved text content. For the closed caption information display mode, the process may extract closed caption information from a program content feed associated with the displayed visual content. For the subtitle display mode, the process 400 may extract subtitle information from a program content feed associated with the displayed visual content.

At decision point 410, the process 400 makes a determination as to whether the configured display mode includes the television setting display mode. When a determination is made that the configured display mode includes the television setting display mode, the process 400 displays a representation of a present television setting information via the LED array at block 412. Example of such a television setting might include a user configuration or profile, a surround sound setting, picture brightness or contrast setting (e.g., vivid or normal), selected channel, signal source, etc.

At decision point 414, the process 400 makes a determination as to whether a selection associated with a television setting control, such as via the input interface 224, has been detected. When a determination is made that a selection associated with a television setting control has not been detected, the process 400 makes a determination at decision point 416 as to whether a selection of a television setting change request via a television setting control of an input device, such as the input interface 224, has been detected. When a determination is made at decision point 416 that a television setting change request via the television setting control of an input device has not been detected, the process 400 makes a determination at decision point 418 as to whether a selection via an input device of a request to change the configured display mode for the LED array has been detected. When a determination is made that a selection via an input device of a request to change the configured display mode for the LED array has not been detected, the process 400 returns to decision point 414 and iterates as described above.

When a determination is made at decision point 414 that a selection associated with a television setting control has been detected, the process 400 returns to block 412 and displays the requested television setting information. For example, the process 400 may detect a request to scroll through the retrieved television setting information. In such a situation, the process 400 may iteratively display portions of the retrieved television setting information via the LED array. Alternatively, the process 400 may detect a request for a different portion of television setting information other than television setting information that was previously retrieved. In such a situation, the process 400 may retrieve additional television setting information from storage, such as in the memory 202. This additional processing is not illustrated within FIG. 4A for ease of illustration purposes.

Returning to the description of decision point 416, when a selection of a television setting change request via a television setting control of the input device has been detected, the process 400 changes the present television setting based upon the detected television setting change request at block 420. At block 422, the process 400 stores the changed television setting to a memory, such as the memory 202. At block 424, the process 400 retrieves information associated with the changed configured display mode for the LED array and displays the information associated with the changed configured display mode via the LED array. The process 400 transitions to decision point 418 and iterates as described above. For example, a change that may be represented with text may be displayed via the LED array. Alternatively, the LED array may be used to convey graphical information, such as a volume staircase and a change associated with volume. In such a situation, the process 400 may display a graphical increasing array of graphical lines from left to right representative of the present volume setting via the LED array and may display an adjusted graphical increasing array of graphical lines from left to right representative of the changed volume setting via the LED array. Many other alternatives for displaying information either textually or graphically are possible and all are considered within the scope of the present subject matter.

With respect to the description of decision point 418, when a determination is made that a selection via an input device of a request to change the configured display mode for the LED array has been detected or when a determination is made at decision point 410 that the configured display mode is not a television setting display mode, the process 400 continues to decision point 426.

At decision point 426, the process 400 makes a determination as to whether the requested change to the display mode for the LED array is to a text display mode. When a determination is made that the change to the display mode for the LED array is to a text display mode, the process 400 extracts program information from a program content feed associated with the displayed visual content at block 428 and displays the extracted program information via the LED array at block 430. The process 400 makes a determination at decision point 432 as to whether a selection via an input device of a request to change the configured display mode for the LED array has been detected. When a determination is made that a selection via an input device of a request to change the configured display mode for the LED array has not been detected, the process 400 iterates as described above by returning to block 428. When a determination is made that a selection via an input device of a request to change the configured display mode for the LED array has been detected at decision point 432 or when a determination is made at decision point 426 that the configured display mode is not a text display mode, the process 400 continues to decision point 434.

At decision point 434, the process 400 makes a determination as to whether the requested change to the display mode for the LED array is to an RSS feed display mode. When a determination is made that the change to the display mode for the LED array is to an RSS feed display mode, the process 400 receives RSS feed information associated with a configured RSS feed, such as via the content interface module 208, at block 436. At block 438, the process 400 displays the received RSS feed information via the LED array. The process 400 makes a determination at decision point 440 as to whether a selection via an input device of a request to change the configured display mode for the LED array has been detected. When a determination is made that a selection via an input device of a request to change the configured display mode for the LED array has not been detected, the process 400 iterates as described above by returning to block 436. When a determination is made that a selection via an input device of a request to change the configured display mode for the LED array has been detected at decision point 440 or when a determination is made at decision point 434 that the configured display mode is not RSS feed display mode, the process 400 transitions to decision point 442 to continue processing as shown and described in association with FIG. 4B.

FIG. 4B illustrates a second portion of an example of an implementation of the process 400 for automated control of illuminated bezel information display. At decision point 442, the process 400 makes a determination as to whether the requested change to the display mode for the LED array is to a text message display mode. When a determination is made that the change to the display mode for the LED array is to a text message display mode, the process 400 makes a determination at decision point 444 as to whether any text message has been received, such as via the content interface module 208. When a determination is made that no text message has been received, the process 400 makes a determination at decision point 446 as to whether any text message input has been detected, such as via an input device associated with the input interface 224. When a determination is made that no text message input has been received, the process 400 makes a determination at decision point 448 as to whether a selection via an input device of a request to change the configured display mode for the LED array has been detected. When a determination is made that a request to change the configured display mode for the LED array has not been detected, the process 400 iterates as described above by returning to decision point 444.

When a determination is made at decision point 444 that a text message has been received, the process 400 receives text message information associated with a text message user account, such as via the content interface module 208, at block 450. At block 452, the process 400 displays the received text message information via the LED array and returns to decision point 446.

When a determination is made at decision point 446 that text message input has been detected, the process 400 displays the text message input via the LED array at block 454. At decision point 456, the process 400 makes a determination as to whether a selection of a request to send the text message input as a text message has been detected, such as via an input device associated with the input interface 224. When a determination is made at decision point 456 that a selection of a request to send the text message input as a text message has not been detected, the process 400 returns to decision point 446 and iterates as described above until a selection of a request to send the text message input as a text message has been detected. When a determination is made at decision point 456 that a selection of a request to send the text message input as a text message has been detected, the process 400 sends the text message input as a text message to the text message user account, such as via the content interface module 208, at block 458. The process 400 transitions to decision point 448 and iterates as described above.

When a determination is made that a selection via an input device of a request to change the configured display mode for the LED array has been detected at decision point 448 or when a determination is made at decision point 442 that the configured display mode is not a text message display mode, the process 400 transitions to decision point 460 to make a determination as to whether a scrolling text mode has been selected. When a determination is made that a scrolling text mode has been selected, the process 400 displays scrolling text across the LED array at block 462. The scrolling text may be associated with any configured or selected information source (not shown), such as a news information source, a stock information source, a sports information source, or other information source. Further, the scrolling text that is displayed may be a pre-configured message, channel information associated with displayed content, or other information. The process 400 makes a determination at decision point 464 as to whether a selection via an input device of a request to change the configured display mode for the LED array has been detected. When a determination is made that a request to change the configured display mode for the LED array has not been detected, the process 400 iterates as described above by returning to block 462 to display additional scrolling text.

When a determination is made that a selection via an input device of a request to change the configured display mode for the LED array has been detected at decision point 464 or when a determination is made at decision point 460 that the configured display mode is not a scrolling text display mode, the process 400 transitions to decision point 466 to make a determination as to whether an incoming telephone call has been detected. When a determination is made that an incoming telephone call has been detected via a telephone interface associated with the display device, such as the content interface module 208, the process 400 displays information associated with the incoming telephone call at block 468. The process 400 makes a determination at decision point 470 as to whether a selection via an input device of a request to change the configured display mode for the LED array has been detected. When a determination is made that a request to change the configured display mode for the LED array has not been detected, the process 400 iterates as described above by returning to block 468 to display additional information associated with the telephone call. Though additional processing for completion or answering of a telephone call is not illustrated within FIG. 4B for ease of illustration purposes, it is understood that such processing is considered within the scope of the present subject matter. When a determination is made that a selection via an input device of a request to change the configured display mode for the LED array has been detected at decision point 470 or when a determination is made at decision point 466 that a telephone call has not been detected, the process 400 transitions to decision point 472 to continue processing as shown and described in association with FIG. 4C.

FIG. 4C illustrates a third portion of an example of an implementation of the process 400 for automated control of illuminated bezel information display. At decision point 472, the process 400 makes a determination as to whether the requested change to the display mode for the LED array is to a static information display mode. When a determination is made that the change to the display mode for the LED array is to a static information display mode, the process 400 displays static information via the LED array at block 474. The displayed static information may be a pre-configured message, channel information associated with displayed content, or other information. The process 400 makes a determination at decision point 476 as to whether an idle time associated with displaying the static information has expired, such as via the timer 220. When a determination is made that the idle time associated with displaying the static information has expired, the process 400 displays a random continually changing pattern via the LED array at block 478. The displayed random continually changing pattern may include a random continually changing color pattern, such as simulating an effect of different colored heated oils in a lava lamp, for example. Many other variations on random continually changing patterns are possible and all are considered within the scope of the present subject matter.

The process 400 makes a determination at decision point 480 as to whether a selection via an input device of a request to change the configured display mode for the LED array has been detected. When a determination is made that a request to change the configured display mode for the LED array has not been detected, the process 400 iterates as described above by returning to block 478 to display additional random continually changing patterns via the LED array.

When a determination is made that a selection via an input device of a request to change the configured display mode for the LED array has been detected at decision point 480 or when a determination is made at decision point 472 that the configured display mode is not a static information display mode, the process 400 transitions to decision point 482 to make a determination as to whether a closed caption information display mode has been selected. When a determination is made that the change to the display mode for the LED array is to a closed caption information display mode, the process 400 extracts closed caption information from a program content feed associated with the displayed visual content, such as via the content interface module 208, at block 484. The process 400 displays the extracted closed caption information via the LED array at block 486. At decision point 488, the process 400 makes a determination as to whether a selection via an input device of a request to change the configured display mode for the LED array has been detected. When a determination is made that a request to change the configured display mode for the LED array has not been detected, the process 400 iterates as described above by returning to block 484 to extract and display additional closed caption information via the LED array.

When a determination is made that a selection via an input device of a request to change the configured display mode for the LED array has been detected at decision point 488 or when a determination is made at decision point 482 that the configured display mode is not a closed caption information display mode, the process 400 transitions to decision point 490 to make a determination as to whether a subtitle display mode has been selected. When a determination is made that the change to the display mode for the LED array is to a subtitle display mode, the process 400 extracts subtitle information from a program content feed associated with the displayed visual content, such as via the content interface module 208, at block 492. The process 400 displays the extracted subtitle information via the LED array at block 494. At decision point 496, the process 400 makes a determination as to whether a selection via an input device of a request to change the configured display mode for the LED array has been detected. When a determination is made that a request to change the configured display mode for the LED array has not been detected, the process 400 iterates as described above by returning to block 492 to extract and display additional subtitle information via the LED array.

When a determination is made that a selection via an input device of a request to change the configured display mode for the LED array has been detected at decision point 496 or when a determination is made at decision point 490 that the configured display mode is not a subtitle display mode, the process 400 transitions to decision point 498 to make a determination as to whether a warning or an error has occurred in association with the display device 100 or selection of a display mode for the LED array. When a determination is made that a warning or an error has occurred in association with the display device 100 or selection of a display mode for the LED array, the process 400 displays a message associated with the respective warning or error via the LED array at block 500. When a determination is made at decision point 498 that a warning or an error has not occurred in association with the display device 100 or upon the display of the message associated with the respective warning or error via the LED array at block 500, the process 400 returns to continue iteratively processing display mode selections for the LED array, as described in association with FIG. 4A above beginning at decision point 410.

As such, the process 400 detects requests to change a display mode for an illuminated bezel information display, such as the illuminated bezel information display 106. Further, information associated with the respective display mode is either retrieved from memory, such as the memory 202, or extracted from an incoming information source, such as via the content interface module 208. Accordingly, the process 400 provides automated control of illuminated bezel information display. It should further be noted that, though certain example display modes for the illuminated bezel information display have been described, many other possibilities exist for display of information via an illuminated bezel information display. For example, a stock ticker display mode may also be implemented along with many other possible types of information display. Accordingly, all such possible types of information display are considered within the scope of the present subject matter.

Based upon the foregoing description, the present subject matter provides for display of visual content, such as a motion picture, television show, or other content, within a display area of a display device. A configured display mode for an illuminated bezel information display located outside of the display area of the display device is determined. Information associated with the configured display mode for the illuminated bezel information display is retrieved and displayed via the illuminated bezel information display. A viewer may view the information displayed via the illuminated bezel information display without obstruction of the visual content displayed within the display area of the display device.

Configured modes for the illuminated bezel information display include, for example, a television setting display mode, a text display mode, a really simple syndication (RSS) feed display mode, a text message display mode, a scrolling text mode, an incoming telephone call mode, a static information display mode, a closed caption information display mode, a subtitle display mode, and a warning or error display mode. Many other display modes for the illuminated bezel information display are possible and all are considered within the scope of the present subject matter.

Operatively, the viewer's viewing experience may be improved by providing interaction and informational capabilities via a two-dimensional illuminated bezel information display with both text and graphics capabilities, including color rendering capabilities, outside of the display area of the display device. By partitioning interaction and information processing to a separate two-dimensional illuminated bezel information display, a viewer may continue to view content without interruption from on-screen display of interaction and information, such as on-screen menus.

Thus, in accord with certain implementations, a method of displaying information associated with a display device involves determining a configured display mode for a two-dimensional light-emitting diode (LED) array located within a bezel of the display device outside of the display area of the display; retrieving information associated with the configured display mode for the two-dimensional LED array; and displaying the information associated with the configured display mode via the two-dimensional LED array.

In certain implementations, the configured display mode includes a television setting display mode; and the method of retrieving the information associated with the configured display mode for the two-dimensional LED array involves retrieving television setting information from a memory; and the method of displaying the information associated with the configured display mode via the two-dimensional LED array involves displaying the television setting information via the two-dimensional LED array. In certain implementations, the method further involves detecting a selection of a television setting control via an input device; and displaying a representation of a present television setting via the two-dimensional LED array. In certain implementations, the method further involves detecting a selection of a television setting change request via the television setting control of the input device; changing the present television setting based upon the television setting change request; storing the changed television setting to the memory; and displaying the changed television setting via the two-dimensional LED array. In certain implementations, the television setting control includes a volume control; and the method of displaying the representation of the present television setting via the two-dimensional LED array involves displaying a graphical increasing array of graphical lines from left to right representative of a present volume setting via the two-dimensional LED array; and the method of displaying the changed television setting via the two-dimensional LED array involves displaying an adjusted graphical increasing array of graphical lines from left to right representative of a changed volume setting via the two-dimensional LED array. In certain implementations, the configured display mode includes a text display mode; and the method of retrieving the information associated with the configured display mode for the two-dimensional LED array involves extracting program information from a program content feed associated with displayed video content; and the method of displaying the information associated with the configured display mode via the two-dimensional LED array involves displaying the extracted program information via the two-dimensional LED array. In certain implementations, the configured display mode includes a really simple syndication (RSS) feed display mode, and the method further involves determining a configured RSS feed associated with the RSS feed display mode; and the method of retrieving the information associated with the configured display mode for the two-dimensional LED array involves receiving RSS feed information associated with the configured RSS feed; and the method of displaying the information associated with the configured display mode via the two-dimensional LED array involves displaying the received RSS feed information via the two-dimensional LED array. In certain implementations, the configured display mode includes a text message display mode; and the method of retrieving the information associated with the configured display mode for the two-dimensional LED array involves receiving text message information associated with a text message user account; and the method of displaying the information associated with the configured display mode via the two-dimensional LED array involves displaying the text message information via the two-dimensional LED array. In certain implementations, the method further involves detecting text message input associated with an input device; and displaying the text message input via the two-dimensional LED array. In certain implementations, the method further involves detecting a selection of a request to send the text message input as a text message via the input device; and sending the text message input as the text message to the text message user account. In certain implementations, the configured display mode includes a scrolling text mode, and the method of displaying the information associated with the configured display mode via the two-dimensional LED array involves displaying text scrolling across the two-dimensional LED array. In certain implementations, the method further involves detecting an incoming telephone call via a telephone interface associated with the display device; and the method of displaying the information associated with the configured display mode via the two-dimensional LED array involves displaying information associated with the incoming telephone call. In certain implementations, the configured display mode includes a static information display mode; and the method of displaying the information associated with the configured display mode via the two-dimensional LED array involves displaying static information via the two-dimensional LED array; and where the method further involves determining that an idle time associated with displaying the static information has expired; and displaying a random continually changing pattern via the two-dimensional LED array. In certain implementations, the method of displaying the random continually changing pattern via the two-dimensional LED array involves displaying a random continually changing color pattern. In certain implementations, the method of displaying the random continually changing pattern via the two-dimensional LED array involves simulating an effect of different colored heated oils in a lava lamp. In certain implementations, the configured display mode includes a closed caption information display mode; and the method of retrieving the information associated with the configured display mode for the two-dimensional LED array involves extracting closed caption information from a program content feed associated with displayed video content; and the method of displaying the information associated with the configured display mode via the two-dimensional LED array involves displaying the extracted closed caption information via the two-dimensional LED array. In certain implementations, the configured display mode includes a subtitle display mode; and the method of retrieving the information associated with the configured display mode for the two-dimensional LED array involves extracting subtitle information from a program content feed associated with displayed video content; and the method of displaying the information associated with the configured display mode via the two-dimensional LED array involves displaying the extracted subtitle information via the two-dimensional LED array. In certain implementations, the method further involves detecting a selection via an input device of a request to change the configured display mode for the two-dimensional LED array; determining the requested change to the configured display mode for the two-dimensional LED array; and changing the configured display mode for the two-dimensional LED array based upon the request to change the configured display mode. In certain implementations, the method further involves retrieving information associated with the changed configured display mode for the two-dimensional LED array; and displaying the information associated with the changed configured display mode via the two-dimensional LED array. In certain implementations, the method further involves determining that one of a warning and an error has occurred in association with the display device; and displaying the one of the warning and the error via the two-dimensional LED array. In certain implementations, the two-dimensional LED array includes a two-dimensional sub-pixel LED array; and where the method involves displaying the information associated with the configured display mode via the two-dimensional LED array, the method further involves displaying the information associated with the configured display mode via the two-dimensional sub-pixel LED array.

In another implementation, a computer readable storage medium may store instructions which, when executed on one or more programmed processors, carry out a process of displaying information associated with a display device which involves determining a configured display mode for a two-dimensional light-emitting diode (LED) array located within a bezel of the display device outside of the display area of the display; retrieving information associated with the configured display mode for the two-dimensional LED array; and displaying the information associated with the configured display mode via the two-dimensional LED array.

An apparatus consistent with another implementation has a display device having a display including a display area; a tuner/decoder device adapted to receive video content that is displayed via the display of the display device; a two-dimensional light-emitting diode (LED) array located within a bezel of the display device outside of the display area of the display; and a bezel display controller module configured to: determine a configured display mode for the two-dimensional LED array; retrieve information associated with the configured display mode for the two-dimensional LED array; and display the information associated with the configured display mode via the two-dimensional LED array.

In certain implementations, the apparatus has a memory; and the configured display mode includes a television setting display mode; and where, in being configured to retrieve the information associated with the configured display mode for the two-dimensional LED array, the bezel display controller module is configured to retrieve television setting information from the memory; and where, in being configured to display the information associated with the configured display mode via the two-dimensional LED array, the bezel display controller module is configured to display the television setting information via the two-dimensional LED array. In certain implementations, the apparatus has an input device; and a processor configured to: detect a selection of a television setting control via the input device; and instruct the bezel display controller module to display a representation of a present television setting via the two-dimensional LED array. In certain implementations, the processor is further configured to: detect a selection of a television setting change request via the television setting control of the input device; change the present television setting based upon the television setting change request; store the changed television setting to the memory; and instruct the bezel display controller module to display the changed television setting via the two-dimensional LED array. In certain implementations, the television setting control includes a volume control; and where in being configured to instruct the bezel display controller module to display the representation of the present television setting via the two-dimensional LED array, the processor is configured to instruct the bezel display controller module to display a graphical increasing array of graphical lines from left to right representative of a present volume setting via the two-dimensional LED array; and in being configured to instruct the bezel display controller module to display the changed television setting via the two-dimensional LED array, the processor is configured to instruct the bezel display controller module to display an adjusted graphical increasing array of graphical lines from left to right representative of a changed volume setting via the two-dimensional LED array. In certain implementations, the configured display mode includes a text display mode; and the apparatus has an input device; and a processor configured to: detect a selection of a television setting control via the input device; and instruct the bezel display controller module to display a representation of a present television setting via the two-dimensional LED array. In certain implementations, the configured display mode includes a really simple syndication (RSS) feed display mode; and the apparatus has a memory; a processor configured to: determine a configured RSS feed associated with the RSS feed display mode; receive RSS feed information associated with the configured RSS feed; store the received RSS feed information within the memory; and instruct the bezel display controller module to display the received RSS feed information via the two-dimensional LED array; and where in being configured to retrieve the information associated with the configured display mode for the two-dimensional LED array, the bezel display controller module is configured to retrieve the received RSS feed information from the memory in response to the instruction from the processor; and in being configured to display the information associated with the configured display mode via the two-dimensional LED array, the bezel display controller module is configured to display the received RSS feed information via the two-dimensional LED array. In certain implementations, the configured display mode includes a text message display mode; and the apparatus has a memory; a processor configured to: receive text message information associated with a text message user account; store the received text message information within the memory; and instruct the bezel display controller module to display the received text message information via the two-dimensional LED array; and where in being configured to retrieve the information associated with the configured display mode for the two-dimensional LED array, the bezel display controller module is configured to retrieve the text message information from the memory in response to the instruction from the processor; and in being configured to display the information associated with the configured display mode via the two-dimensional LED array, the bezel display controller module is configured to display the text message information via the two-dimensional LED array. In certain implementations, the apparatus has an input device; and where the processor is further configured to: detect text message input associated with the input device; and instruct the bezel display controller module to display the text message input via the two-dimensional LED array. In certain implementations, the processor is further configured to: detect a selection of a request to send the text message input as a text message via the input device; and send the text message input as the text message to the text message user account. In certain implementations, the configured display mode includes a scrolling text mode; and where in being configured to display the information associated with the configured display mode via the two-dimensional LED array, the bezel display controller module is configured to display text scrolling across the two-dimensional LED array. In certain implementations, the apparatus has a processor configured to: detect an incoming telephone call via a telephone interface associated with the display device; instruct the bezel display controller module to display information associated with the incoming telephone call via the two-dimensional LED array; and where, in being configured to display the information associated with the configured display mode via the two-dimensional LED array, the bezel display controller module is configured to display information associated with the incoming telephone call in response to the instruction from the processor. In certain implementations, the configured display mode includes a static information display mode; and where, in being configured to display the information associated with the configured display mode via the two-dimensional LED array, the bezel display controller module is configured to display static information via the two-dimensional LED array; and the apparatus has a processor configured to: determine that an idle time associated with displaying the static information has expired; and instruct the bezel display controller module to display a random continually changing pattern via the two-dimensional LED array. In certain implementations, the processor, in being configured to instruct the bezel display controller module to display the random continually changing pattern via the two-dimensional LED array, is configured to instruct the bezel display controller module to display a random continually changing color pattern. In certain implementations, the processor, in being configured to instruct the bezel display controller module to display the random continually changing pattern via the two-dimensional LED array, is configured to instruct the bezel display controller module to simulate an effect of different colored heated oils in a lava lamp via the two-dimensional LED array. In certain implementations, the configured display mode includes a closed caption information display mode; and the apparatus has a memory; a processor configured to: extract closed caption information from a program content feed associated with the displayed video content; store the extracted closed caption information within the memory; and instruct the bezel display controller module to display the extracted closed caption information via the two-dimensional LED array; and where, in being configured to retrieve the information associated with the configured display mode for the two-dimensional LED array, the bezel display controller module is configured to retrieve the extracted closed caption information from the memory in response to the instruction from the processor; and where in being configured to display the information associated with the configured display mode via the two-dimensional LED array, the bezel display controller module is configured to display the extracted closed caption information via the two-dimensional LED array. In certain implementations, the configured display mode includes a subtitle display mode; and the apparatus has a memory; a processor configured to: extract subtitle information from a program content feed associated with the displayed video content; store the extracted subtitle information within the memory; and instruct the bezel display controller module to display the extracted subtitle information via the two-dimensional LED array; and where in being configured to retrieve the information associated with the configured display mode for the two-dimensional LED array, the bezel display controller module is configured to retrieve the extracted subtitle information from the memory in response to the instruction from the processor; and where in being configured to display the information associated with the configured display mode via the two-dimensional LED array, the bezel display controller module is configured to display the extracted subtitle information via the two-dimensional LED array. In certain implementations, the apparatus has an input device; and a processor configured to: detect a selection via the input device of a request to change the configured display mode for the two-dimensional LED array; determine the requested change to the configured display mode for the two-dimensional LED array; and instruct the bezel display controller module to change the configured display mode for the two-dimensional LED array based upon the request to change the configured display mode. In certain implementations, the bezel display controller module is further configured to: retrieve information associated with the changed configured display mode for the two-dimensional LED array; and display the information associated with the changed configured display mode via the two-dimensional LED array. In certain implementations, the apparatus has a processor configured to: determine that one of a warning and an error has occurred in association with the display device; and instruct the bezel display controller module to display the one of the warning and the error via the two-dimensional LED array. In certain implementations, the two-dimensional LED array includes a two-dimensional sub-pixel LED array; and where, in being configured to display the information associated with the configured display mode via the two-dimensional LED array, the bezel display controller module is configured to display the information associated with the configured display mode via the two-dimensional sub-pixel LED array.

While certain embodiments herein were described in conjunction with specific circuitry that carries out the functions described, other embodiments are contemplated in which the circuit functions are carried out using equivalent elements executed on one or more programmed processors. General purpose computers, microprocessor based computers, micro-controllers, optical computers, analog computers, dedicated processors, application specific circuits and/or dedicated hard wired logic and analog circuitry may be used to construct alternative equivalent embodiments. Other embodiments could be implemented using hardware component equivalents such as special purpose hardware, dedicated processors or combinations thereof.

Certain embodiments may be implemented using one or more programmed processors executing programming instructions that in certain instances are broadly described above in flow chart form that can be stored on any suitable electronic or computer readable storage medium (such as, for example, disc storage, Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies). However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. A method of displaying information associated with a display device, comprising:
determining a configured display mode for a two-dimensional light-emitting diode (LED) array located within a bezel of the display device outside of the display area of the display;
retrieving information associated with the configured display mode for the two-dimensional LED array; and
displaying the information associated with the configured display mode via the two-dimensional LED array.

2. The method according to claim 1, where the configured display mode comprises a television setting display mode and where:
retrieving the information associated with the configured display mode for the two-dimensional LED array comprises retrieving television setting information from a memory; and
displaying the information associated with the configured display mode via the two-dimensional LED array comprises displaying the television setting information via the two-dimensional LED array.

3. The method according to claim 2, further comprising:
detecting a selection of a television setting control via an input device; and
displaying a representation of a present television setting via the two-dimensional LED array.

4. The method according to claim 3, further comprising:
detecting a selection of a television setting change request via the television setting control of the input device;
changing the present television setting based upon the television setting change request;
storing the changed television setting to the memory; and
displaying the changed television setting via the two-dimensional LED array.

5. The method according to claim 4, where the television setting control comprises a volume control and where:
displaying the representation of the present television setting via the two-dimensional LED array comprises displaying a graphical increasing array of graphical lines from left to right representative of a present volume setting via the two-dimensional LED array; and
displaying the changed television setting via the two-dimensional LED array comprises displaying an adjusted graphical increasing array of graphical lines from left to right representative of a changed volume setting via the two-dimensional LED array.

6. The method according to claim 1, where the configured display mode comprises a text display mode and where:
retrieving the information associated with the configured display mode for the two-dimensional LED array comprises extracting program information from a program content feed associated with displayed video content; and
displaying the information associated with the configured display mode via the two-dimensional LED array comprises displaying the extracted program information via the two-dimensional LED array.

7. The method according to claim 1, where the configured display mode comprises a really simple syndication (RSS) feed display mode and further comprising determining a configured RSS feed associated with the RSS feed display mode, and where:
retrieving the information associated with the configured display mode for the two-dimensional LED array comprises receiving RSS feed information associated with the configured RSS feed; and
displaying the information associated with the configured display mode via the two-dimensional LED array comprises displaying the received RSS feed information via the two-dimensional LED array.

8. The method according to claim 1, where the configured display mode comprises a text message display mode and where:
retrieving the information associated with the configured display mode for the two-dimensional LED array comprises receiving text message information associated with a text message user account; and
displaying the information associated with the configured display mode via the two-dimensional LED array comprises displaying the text message information via the two-dimensional LED array.

9. The method according to claim 8, further comprising:
detecting text message input associated with an input device; and
displaying the text message input via the two-dimensional LED array.

10. The method according to claim 9, further comprising:
detecting a selection of a request to send the text message input as a text message via the input device; and
sending the text message input as the text message to the text message user account.

11. The method according to claim 1, where the configured display mode comprises a scrolling text mode and where displaying the information associated with the configured display mode via the two-dimensional LED array comprises displaying text scrolling across the two-dimensional LED array.

12. The method according to claim 1, further comprising:
detecting an incoming telephone call via a telephone interface associated with the display device; and
where displaying the information associated with the configured display mode via the two-dimensional LED array comprises displaying information associated with the incoming telephone call.

13. The method according to claim 1, where the configured display mode comprises a static information display mode and where displaying the information associated with the configured display mode via the two-dimensional LED array comprises displaying static information via the two-dimensional LED array and further comprising:
determining that an idle time associated with displaying the static information has expired; and
displaying a random continually changing pattern via the two-dimensional LED array.

14. The method according to claim 13, where displaying the random continually changing pattern via the two-dimensional LED array comprises displaying a random continually changing color pattern.

15. The method according to claim 13, where displaying the random continually changing pattern via the two-dimensional LED array comprises simulating an effect of different colored heated oils in a lava lamp.

16. The method according to claim 1, where the configured display mode comprises a closed caption information display mode and where:
retrieving the information associated with the configured display mode for the two-dimensional LED array comprises extracting closed caption information from a program content feed associated with displayed video content; and
displaying the information associated with the configured display mode via the two-dimensional LED array comprises displaying the extracted closed caption information via the two-dimensional LED array.

17. The method according to claim 1, where the configured display mode comprises a subtitle display mode and where:
retrieving the information associated with the configured display mode for the two-dimensional LED array comprises extracting subtitle information from a program content feed associated with displayed video content; and
displaying the information associated with the configured display mode via the two-dimensional LED array comprises displaying the extracted subtitle information via the two-dimensional LED array.

18. The method according to claim 1, further comprising:
detecting a selection via an input device of a request to change the configured display mode for the two-dimensional LED array;
determining the requested change to the configured display mode for the two-dimensional LED array; and
changing the configured display mode for the two-dimensional LED array based upon the request to change the configured display mode.

19. The method according to claim 18, further comprising:
retrieving information associated with the changed configured display mode for the two-dimensional LED array; and
displaying the information associated with the changed configured display mode via the two-dimensional LED array.

20. The method according to claim 1, further comprising:
determining that one of a warning and an error has occurred in association with the display device; and
displaying the one of the warning and the error via the two-dimensional LED array.

21. The method according to claim 1, where the two-dimensional LED array comprises a two-dimensional sub-pixel LED array and displaying the information associated with the configured display mode via the two-dimensional LED array comprises displaying the information associated with the configured display mode via the two-dimensional sub-pixel LED array.

22. A computer readable storage medium storing instructions which, when executed on one or more programmed processors, carry out a process according to claim 1.

23. An apparatus, comprising:
a display device having a display comprising a display area;
a tuner/decoder device that receives video content that is displayed via the display of the display device;
a two-dimensional light-emitting diode (LED) array located within a bezel of the display device outside of the display area of the display; and
a bezel display controller module configured to:
determine a configured display mode for the two-dimensional LED array;
retrieve information associated with the configured display mode for the two-dimensional LED array; and
display the information associated with the configured display mode via the two-dimensional LED array.

24. The apparatus according to claim 23, further comprising:
a memory; and
where the configured display mode comprises a television setting display mode and where:
in being configured to retrieve the information associated with the configured display mode for the two-dimensional LED array, the bezel display controller module is configured to retrieve television setting information from the memory; and
in being configured to display the information associated with the configured display mode via the two-dimensional LED array, the bezel display controller module is configured to display the television setting information via the two-dimensional LED array.

25. The apparatus according to claim 24, further comprising:
an input device; and
a processor configured to:
detect a selection of a television setting control via the input device; and
instruct the bezel display controller module to display a representation of a present television setting via the two-dimensional LED array.

26. The apparatus according to claim 25, where the processor is further configured to:
detect a selection of a television setting change request via the television setting control of the input device;
change the present television setting based upon the television setting change request;
store the changed television setting to the memory; and
instruct the bezel display controller module to display the changed television setting via the two-dimensional LED array.

27. The apparatus according to claim 26, where the television setting control comprises a volume control and where:
in being configured to instruct the bezel display controller module to display the representation of the present television setting via the two-dimensional LED array, the processor is configured to instruct the bezel display controller module to display a graphical increasing array of graphical lines from left to right representative of a present volume setting via the two-dimensional LED array; and
in being configured to instruct the bezel display controller module to display the changed television setting via the two-dimensional LED array, the processor is configured to instruct the bezel display controller module to display an adjusted graphical increasing array of graphical lines from left to right representative of a changed volume setting via the two-dimensional LED array.

28. The apparatus according to claim 23, where the configured display mode comprises a text display mode and further comprising:
a memory;
a processor configured to:
extract program information from a program content feed associated with the displayed video content;
store the extracted program content within the memory; and
instruct the bezel display controller module to display the extracted program information via the two-dimensional LED array; and
where:
in being configured to retrieve the information associated with the configured display mode for the two-dimensional LED array, the bezel display controller module is configured to retrieve the extracted program information from the memory in response to the instruction from the processor; and
in being configured to display the information associated with the configured display mode via the two-dimensional LED array, the bezel display controller module is configured to display the extracted program information via the two-dimensional LED array.

29. The apparatus according to claim 23, where the configured display mode comprises a really simple syndication (RSS) feed display mode and further comprising:
a memory;
a processor configured to:
determine a configured RSS feed associated with the RSS feed display mode;
receive RSS feed information associated with the configured RSS feed;
store the received RSS feed information within the memory; and
instruct the bezel display controller module to display the received RSS feed information via the two-dimensional LED array; and
where:
in being configured to retrieve the information associated with the configured display mode for the two-dimensional LED array, the bezel display controller module is configured to retrieve the received RSS feed information from the memory in response to the instruction from the processor; and
in being configured to display the information associated with the configured display mode via the two-dimensional LED array, the bezel display controller module is configured to display the received RSS feed information via the two-dimensional LED array.

30. The apparatus according to claim 23, where the configured display mode comprises a text message display mode and further comprising:
a memory;
a processor configured to:
receive text message information associated with a text message user account;
store the received text message information within the memory; and
instruct the bezel display controller module to display the received text message information via the two-dimensional LED array; and
where:
in being configured to retrieve the information associated with the configured display mode for the two-dimensional LED array, the bezel display controller module is configured to retrieve the text message information from the memory in response to the instruction from the processor; and
in being configured to display the information associated with the configured display mode via the two-dimensional LED array, the bezel display controller module is configured to display the text message information via the two-dimensional LED array.

31. The apparatus according to claim 30, further comprising:
an input device; and
where the processor is further configured to:
detect text message input associated with the input device; and
instruct the bezel display controller module to display the text message input via the two-dimensional LED array.

32. The apparatus according to claim 31, where the processor is further configured to:
detect a selection of a request to send the text message input as a text message via the input device; and
send the text message input as the text message to the text message user account.

33. The apparatus according to claim 23, where the configured display mode comprises a scrolling text mode and where, in being configured to display the information associated with the configured display mode via the two-dimensional LED array, the bezel display controller module is configured to display text scrolling across the two-dimensional LED array.

34. The apparatus according to claim 23, further comprising a processor configured to:
detect an incoming telephone call via a telephone interface associated with the display device;
instruct the bezel display controller module to display information associated with the incoming telephone call via the two-dimensional LED array; and
where, in being configured to display the information associated with the configured display mode via the two-dimensional LED array, the bezel display controller module is configured to display information associated with the incoming telephone call in response to the instruction from the processor.

35. The apparatus according to claim 23, where the configured display mode comprises a static information display mode and where, in being configured to display the information associated with the configured display mode via the two-dimensional LED array, the bezel display controller module is configured to display static information via the two-dimensional LED array and further comprising a processor configured to:
determine that an idle time associated with displaying the static information has expired; and
instruct the bezel display controller module to display a random continually changing pattern via the two-dimensional LED array.

36. The apparatus according to claim 35, where, in being configured to instruct the bezel display controller module to display the random continually changing pattern via the two-dimensional LED array, the processor is configured to instruct the bezel display controller module to display a random continually changing color pattern.

37. The apparatus according to claim 35, where, in being configured to instruct the bezel display controller module to display the random continually changing pattern via the two-dimensional LED array, the processor is configured to instruct the bezel display controller module to simulate an effect of different colored heated oils in a lava lamp via the two-dimensional LED array.

38. The apparatus according to claim 23, where the configured display mode comprises a closed caption information display mode and further comprising:
a memory;
a processor configured to:
extract closed caption information from a program content feed associated with the displayed video content;
store the extracted closed caption information within the memory; and
instruct the bezel display controller module to display the extracted closed caption information via the two-dimensional LED array; and
where:
in being configured to retrieve the information associated with the configured display mode for the two-dimensional LED array, the bezel display controller module is configured to retrieve the extracted closed caption information from the memory in response to the instruction from the processor; and
in being configured to display the information associated with the configured display mode via the two-dimensional LED array, the bezel display controller module is configured to display the extracted closed caption information via the two-dimensional LED array.

39. The apparatus according to claim 23, where the configured display mode comprises a subtitle display mode and further comprising:
a memory;
a processor configured to:
extract subtitle information from a program content feed associated with the displayed video content;
store the extracted subtitle information within the memory; and
instruct the bezel display controller module to display the extracted subtitle information via the two-dimensional LED array; and
where:
in being configured to retrieve the information associated with the configured display mode for the two-dimensional LED array, the bezel display controller module is configured to retrieve the extracted subtitle information from the memory in response to the instruction from the processor; and
in being configured to display the information associated with the configured display mode via the two-dimensional LED array, the bezel display controller module is configured to display the extracted subtitle information via the two-dimensional LED array.

40. The apparatus according to claim 23, further comprising:
an input device; and
a processor configured to:
detect a selection via the input device of a request to change the configured display mode for the two-dimensional LED array;
determine the requested change to the configured display mode for the two-dimensional LED array; and
instruct the bezel display controller module to change the configured display mode for the two-dimensional LED array based upon the request to change the configured display mode.

41. The apparatus according to claim 40, where the bezel display controller module is further configured to:
retrieve information associated with the changed configured display mode for the two-dimensional LED array; and
display the information associated with the changed configured display mode via the two-dimensional LED array.

42. The apparatus according to claim 23, further comprising a processor configured to:
determine that one of a warning and an error has occurred in association with the display device; and
instruct the bezel display controller module to display the one of the warning and the error via the two-dimensional LED array.

43. The apparatus according to claim 23, where the two-dimensional LED array comprises a two-dimensional sub-pixel LED array and where, in being configured to display the information associated with the configured display mode via the two-dimensional LED array, the bezel display controller module is configured to display the information associated with the configured display mode via the two-dimensional sub-pixel LED array.
